(19) United States
(12) Patent Application Publication
(10) Pub. No.: US 2016/0051014 A1
(43) Pub. Date: Feb. 25, 2016

(54) METHOD AND APPARATUS FOR SECURING AND ADJUSTING A WRIST STRAP

(71) Applicant: Nathan Resnick, Chevy Chase, MD (US)

(72) Inventor: Nathan Resnick, Chevy Chase, MD (US)

(21) Appl. No.: 14/537,462

(22) Filed: Nov. 10, 2014

Related U.S. Application Data
(60) Provisional application No. 62/068,894, filed on Oct. 27, 2014.
(60) Provisional application No. 62/040,212, filed on Aug. 21, 2014.

(51) Int. Cl. A44C 5/20; A44B 11/16; G04B 37/00; A44B 11/06

(52) U.S. Cl. CPC A44C 5/2066; A44B 11/06; A44B 11/16; G04B 37/0008

(57) ABSTRACT

Provided is a buckle design that does not require holes in the strap that engage the buckle to secure the strap. Also provided is a strap comprising a fixed end and opposed free end is provided. Additionally provided is a watch face that comprises a woven material applied to the planer surface thereon.

### CROSS-REFERENCE TO RELATED APPLICATIONS

This application claims the benefit of U.S. Provisional Application No. 62/040,212, filed Aug. 21, 2014, and U.S. Provisional Application No. 62/068,894, filed Oct. 27, 2014, both of which are incorporated by reference herein in their entirety.

### BACKGROUND OF THE INVENTION

(1) Field of the Invention

The present application generally relates to buckles. More specifically, the present invention is directed to a buckle, useful for example, in combination with a strap, to hold a watch onto a wrist, where the strap does not need holes to engage the buckle.

(2) Description of the related art

Wearers of straps whether it is a watch strap or any other device, often require additional sizing options and comfort. Current straps are either fixed size and unable to accommodate the wearers varying bulk, or large step sizes define by holes that commonly are too tight or too loose.

Buckles and their straps are also known to incur damages when used for significant amounts of time that may exceed their design, but when they are still needed by the wearer. For example some current buckles damage the strap material through the pressure the buckle puts on the strap. Many existing buckles wear holes in the strap by putting pressure on the strap, damaging the strap material.

The present invention addresses the above problems by providing a buckle design that can engage a strap with many small adjustment settings without requiring a strap that has holes that engage the buckle.

### BRIEF SUMMARY OF THE INVENTION

The present invention provides a buckle design that does not require holes in the strap that engage the buckle to secure the strap. Thus, in some embodiments, a buckle is provided that has a mounting end and an opposed receiving end. In these embodiments, the mounting end is adapted to attach to a strap or another device and the receiving end is adapted to receive a strap. Also, the buckle comprises an upper plate and opposed lower plate; the upper plate and lower plate combine to form an interior space that can receive a strap inserted into the receiving end of the buckle; and the upper plate and lower plate further combine to form a mechanism in the interior space that, when the mechanism is engaged, prevents the strap from being removed from the interior space when inserted into the receiving end and, when the mechanism is disengaged, allows the strap to be removed. In this buckle design, the buckle can engage a strap without engaging holes that pass through the strap.

In other embodiments, a strap comprising a fixed end and opposed free end is provided. The fixed end of the strap is adapted to attach permanently to a buckle or another device, and the free end is substantially adapted for insertion into a buckle. In these embodiments, the free end is constructed without engaging holes that pass through the strap.

Additionally provided is a watch face comprising a substantially planar surface, thereon suitable for application of a woven material. The watch face further comprises a woven material applied to the planer surface thereon such that the material forms the surface of said watch face, and upon which the time keeping dial pieces may be applied, substantially comprised of the arms and numerals or increments, as is customary or desired in the art.

### BRIEF DESCRIPTION OF THE DRAWINGS

FIG. 1 is an aspect view of the handle buckle assembled.

FIG. 2 is a side profile mechanical drawing of the handle buckle.

FIG. 3 is an exploded aspect view of the handle buckle from the receiving end.

FIG. 4 is an aspect view of the handle buckle flap.

FIG. 5 is a side profile mechanical drawing of the button buckle.

FIG. 6 is a top profile mechanical drawing of the button buckle.

FIG. 7 is an aspect view of the spring bar shoulder pin.

FIG. 8 is an end profile mechanical drawing of the button buckle from the receiving end.

FIG. 9 is a side profile mechanical drawing of the latch buckle.

FIG. 10 is an aspect view of the under side of the upper plate of the latch buckle.

FIG. 11 is an aspect view of the exterior side of the lower plate of the latch buckle.

FIG. 12 is an end profile mechanical drawing of the upper plate of the latch buckle from the mounting end.

FIG. 13 is an end profile mechanical drawing of the lower plate of the latch buckle from the mounting end.

FIG. 14 is a side profile aspect of the latch buckle viewed from side A.

FIG. 15 is a composite profile view of three embodiments of the buckle with the strap oriented to the receiving side and in the case of the handle buckle with the strap inserted into the buckle and engaged by the flap.

FIG. 16 is a composite view of a wrist watch embodiment of the handle buckle, viewed from a bottom profile and a side profile of the exploded wrist watch assembly.

FIG. 17 is a top profile mechanical drawing of the strap from the working side.

FIG. 18 is a side profile mechanical drawing of the strap clearly depicting the saw tooth profile of the embedded engagement bar.

FIG. 19 is a top profile aspect of the woven material watch face with stripes.

FIG. 20 is a top profile aspect of 14 variations of designs for the watch face.

### DETAILED DESCRIPTION OF THE INVENTION

As used herein, the singular forms “a”, “an” and “the” are intended to include the plural forms as well, unless the context clearly indicates otherwise. Additionally, the use of “or” is intended to include “and/or”, unless the context clearly indicates otherwise.

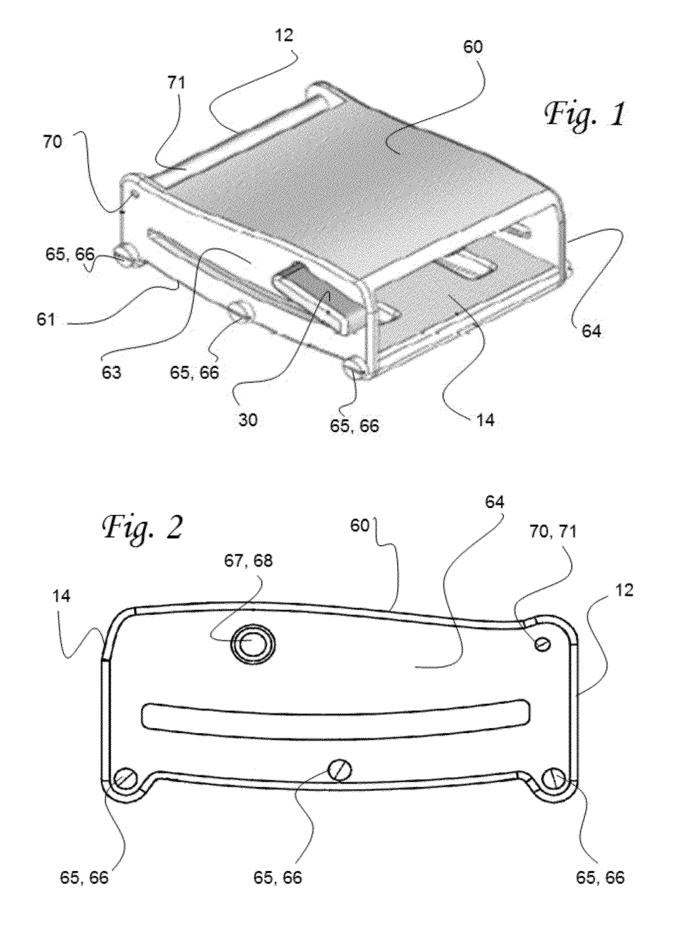

Provided herewith is a buckle, an embodiment of which is illustrated in FIG. 1, that has a mounting end 12 and an opposed receiving end 14. In the embodiment illustrated in FIG. 2 the mounting end 12 is adapted to attach to a strap or another device and the receiving end 14 is adapted to receive a strap.

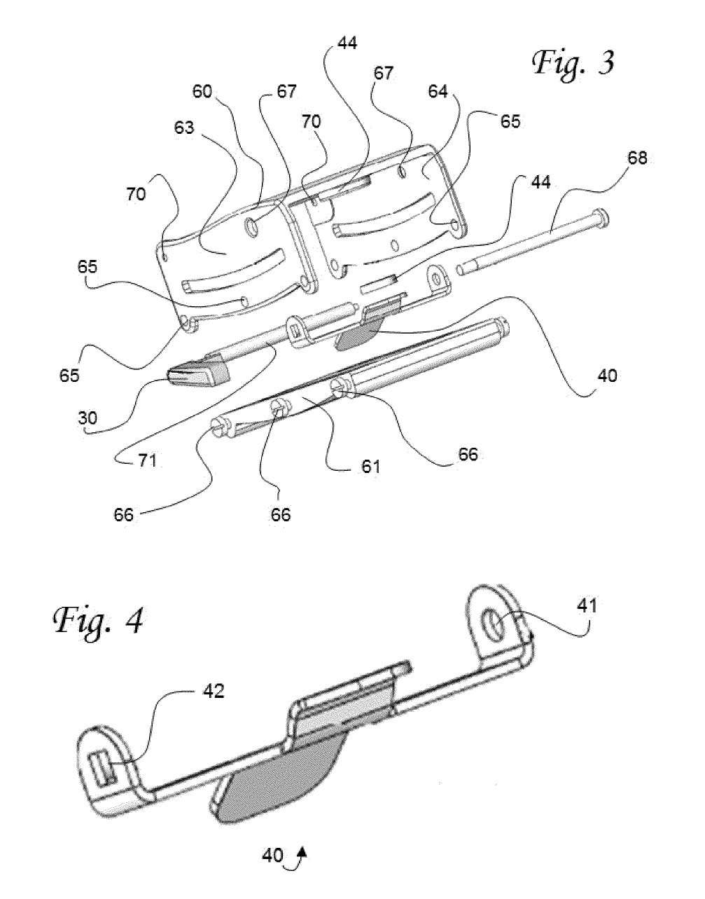

In the embodiment illustrated in FIG. 3 the buckle further comprises an upper plate 60 and opposed lower plate 61. In the embodiment illustrated in FIG. 1 the upper plate 60 and lower plate 61 combine to form an interior space that can receive a strap inserted into the receiving end 14 of the buckle. In the embodiment illustrated in FIG. 3 the upper plate 60 and lower plate 61 further combine to form a mechanism in the interior space that, when the mechanism is engaged, prevents the strap from being removed from the interior space when inserted into the receiving end 14 and, when the mechanism is disengaged, allows the strap to be removed. In this buckle design, the buckle can engage a strap without engaging holes that pass through the strap.

In some embodiments, the buckle illustrated in FIG. 3 further comprises a side A 63 and side B 64. Side A 63 and side B 64 join the buckle upper plate 60 with the lower plate 61. Side A 63 and side B 64 are comprised of substantially planer plates with openings 65 to allow fasteners 66 to pass through and connect the upper plate 60 to the lower plate 61. In some embodiments side A 63 has an opening 67 aligned with a similar opening 67 on side B 64 to support a pin 68 that protrudes inward through the interior of the buckle. The pin 68 and assists the mechanism to engage and disengage the strap.

In an embodiment illustrated in FIG. 3 a buckle's side A 63 has an opening 70 aligned with a similar opening 70 on side B 64 to support a spring bar shoulder pin 71. In an embodiment of the buckle illustrated in FIG. 1 the spring bar shoulder pin 71 attaches the buckle's mounting end 12 to a strap.

In this buckle design, illustrated in FIG. 2, the buckle can engage a strap inserted in the receiving end 14. In an embodiment illustrated in FIG. 3, the mechanism formed in the buckle's interior space comprises an inward directed flap 40, which engages a strap to prevent withdrawal of the strap from the buckle. As illustrated in FIG. 4, an embodiment of the flap 40 provides for openings 41 and 42 on the sides of flap 40. As illustrated in FIG. 3, a pin 68 passes through the opening 67 on the buckle side B 64, then through the openings 41 and 42 on the flap 40, and finally through opening 67 on the buckle side A 63.

In an embodiment of the buckle illustrated in FIG. 3 a pin 68 supporting the flap 40, is able to swivel about an axis perpendicular to the path of a strap inserted into the buckle. In this embodiment a force is provided by magnet 44 to the opposing end of the flap 40 such that the flap 40 is biased toward the buckle lower plate 61. In this embodiment the flap 40 is biased toward the buckle lower plate 61 by a magnet 44 such that the flap 40 engages a strap when inserted into the buckle. In some embodiments the biasing force is provided by a spring connected to the opposing end of flap 40 and further connected to the buckle upper plate 60, such that the flap 40 is biased toward the buckle lower plate 61 such that the flap 40 engages a strap when inserted into the buckle.

In the embodiment illustrated in FIG. 3 the pin 68 supporting the flap 40, is able to swivel about an axis perpendicular to the path of a strap inserted into the buckle. In this embodiment a handle 30 is attached to the end of pin 68 passing through the opening 67 on the buckle side A 63. When force is applied to the handle 30 a rotational forces is translated to the pin 68 and to the flap 40, wherein the flap 40 can disengage a strap to allow withdrawal of the strap from the buckle.

In the buckle embodied by the illustration in FIG. 3 withdrawal of a strap is provided by disengagement of the flap 40 when the handle 30 translates a rotational force to the flap 40 such that the flap 40 moves up and out of the path of the strap.

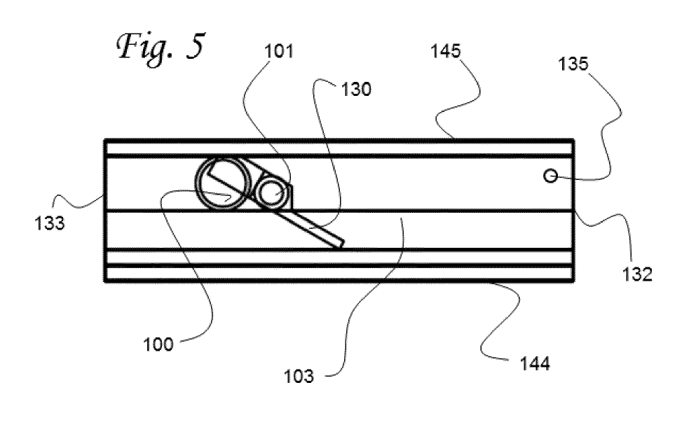

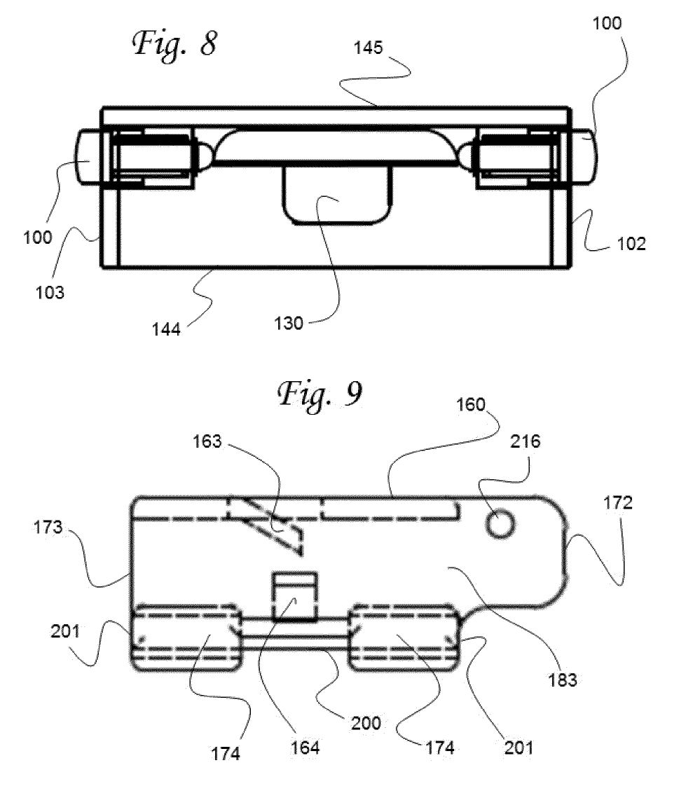

In the buckle embodied by the illustration in FIG. 5 a mounting end 132 and an opposed receiving end 132 are provided. In this embodiment of the buckle an inward directed flap 130 is provided in the interior of the buckle, as part of a mechanism for engaging a strap inserted into the receiving end 133. In this embodiment of the buckle, as illustrated in FIG. 6, a pin 101 oriented perpendicular to the path of a strap inserted into the buckle, inserted through openings on sides A 102 and B 130 of the buckle's upper plate 145 acts as a fulcrum supporting the flap 130. In this embodiment illustrated in FIG. 5 the flap 130 is biased toward the buckle's lower plate 144, such that the flap 130 engages a strap inserted into the buckle. In this embodiment of the buckle further, as illustrated in FIG. 8, provides at least one button 100 operably connected to the opposing end of the flap 130.

In an embodiment illustrated in FIG. 3 a buckle's side A 63 has an opening 70 aligned with a similar opening 70 on side B 64 to support a spring bar shoulder pin 71. In an embodiment of the buckle illustrated in FIG. 1 the spring bar shoulder pin 71 attaches the buckle's mounting end 12 to a strap.

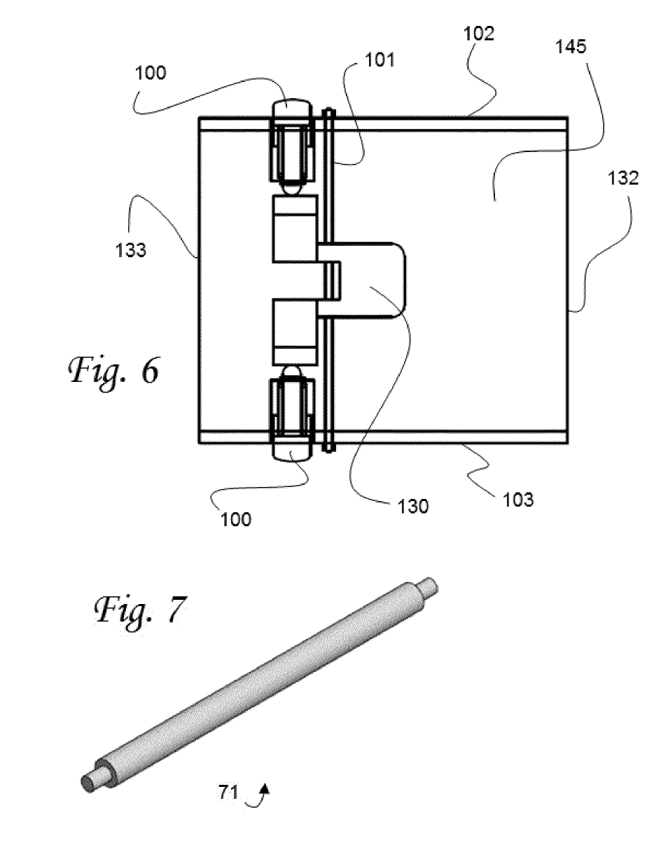

In an embodiment illustrated in FIG. 5 a buckle's side B 103 has an opening 135 aligned with a similar opening 135 on opposing side A 102, illustrated in FIG. 6, to support a spring bar shoulder pin 71, illustrated in FIG. 7. In an embodiment of the buckle illustrated in FIG. 5 the spring bar shoulder pin 71, illustrated in FIG. 7, attaches the buckle's mounting end 132 to a strap.

In the embodiment illustrated in FIG. 6 the pin 101 supporting the flap 130 provides the flap 130 freedom to swivel about an axis perpendicular to the path of a strap inserted into the buckle. In this embodiment, illustrated in FIG. 8, at least one button 100 is operably connected to the flap 130 such that when at least one button 100 is pushed the buckle's interior mechanism translates a force, through fulcrum support provided by the pin 101 in FIG. 6, to the flap 130, wherein the flap 130 can disengage a strap to enable withdrawal of the strap from the buckle. In another embodiment illustrated in FIG. 8, simultaneously pushing a set of opposing buttons 100 translates a force to the flap 130 wherein the flap 130 can disengage a strap to enable withdrawal from the buckle.

In the buckle embodied by the illustration in FIG. 5 withdrawal of a strap is provided by disengagement of the flap 130 when the at least one button 100 translates a force to the flap 130 such that the flap 130 moves up and out of the path of the strap. In another embodiment illustrated in FIG. 8, simultaneously a set of opposing buttons 100 translate a force to flap 130 such that flap 130 moves up and out of the path of the strap.

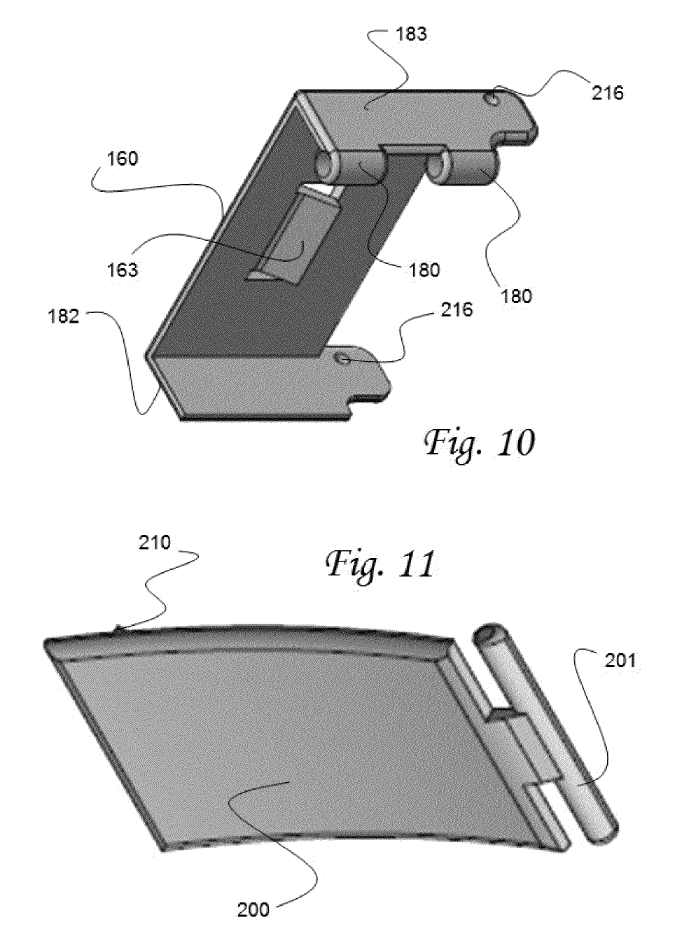

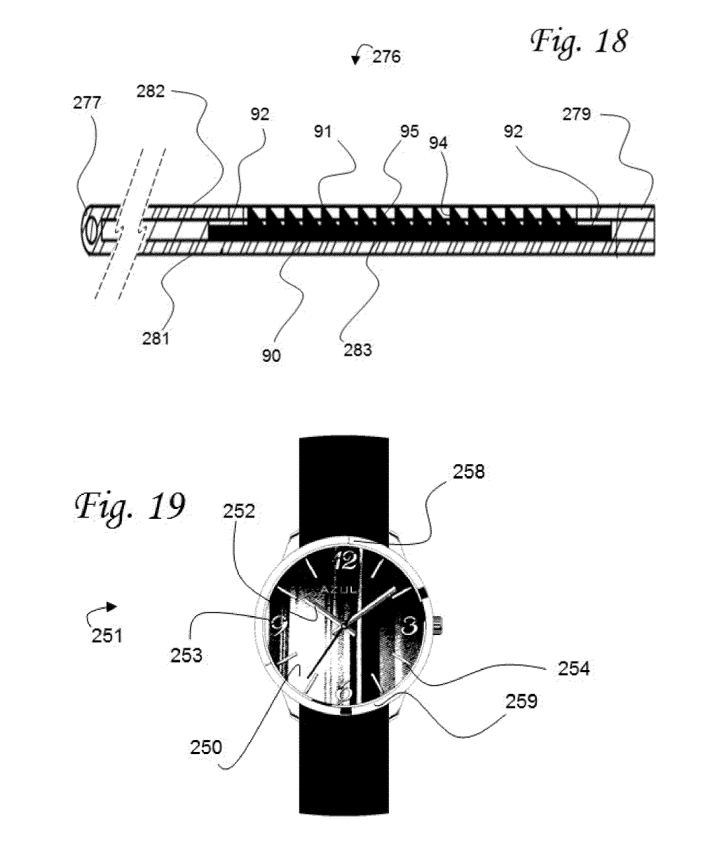

In the buckle embodied by illustration in FIG. 9 a mounting end 172 and an opposed receiving end 173 is provided. In this embodiment illustrated in FIG. 10 the upper plate 160 is provided with a hinge 180. In this embodiment as further illustrated in FIG. 11 the buckle lower plate 200 is provided with an attached pin 201. In an embodiment illustrated in FIGS. 9 and 18 the buckle lower plate 200 permanently connects to upper plate 160 by inserting the attached pin 201 into the hinge 180. In this embodiment illustrated in FIG. 9 the hinge joint 174 formed by inserting the pin 201 into the upper plate 160 is oriented parallel to path of a strap inserted into the buckle's receiving end 173. In this embodiment, illustrated in FIG. 9, the hinge joint 174 further enables the lower plate 200 and the upper plate 160 to swing apart and together about an axis parallel to the path of a strap inserted into the buckle.

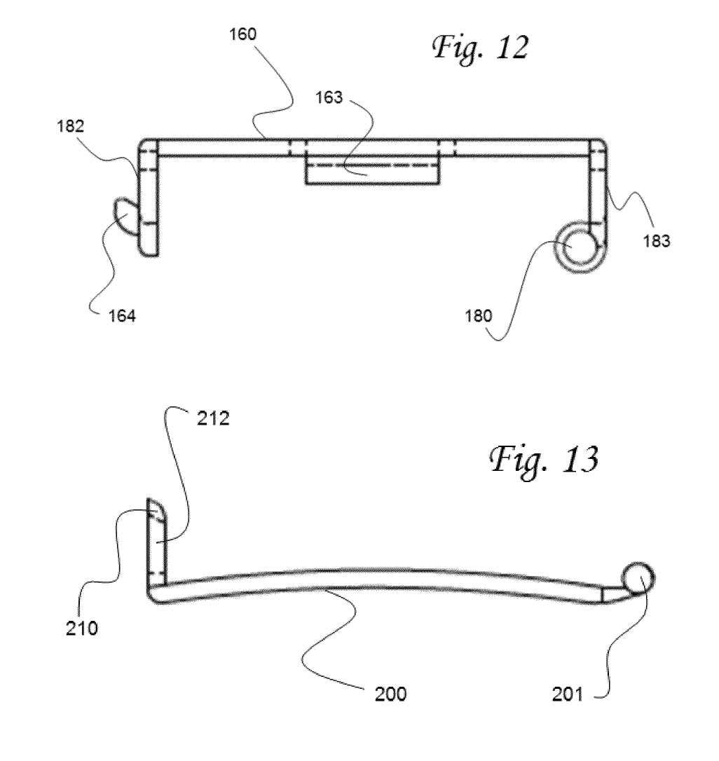

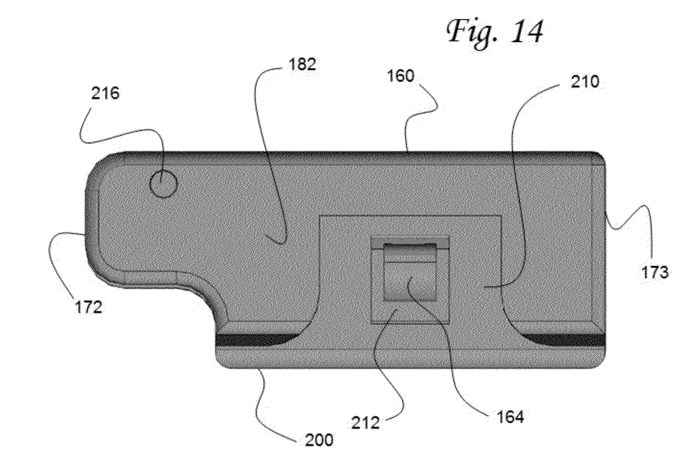

In the buckle embodied in FIG. 9 a buckle upper plate 160 is provided an inward- directed flap 163 formed as a fixed protrusion on the upper plate 160, depicted as well in illustration FIG. 10. Further, as illustrated in FIG. 12, the upper plate 160 is provided an outward-directed hook 164, protruding from side A 182 of the buckle. The embodiment illustrated in FIG. 9 the lower plate 200 is further provided a latch 210 with a slot 212, illustrated in FIG. 13. In the embodiment illustrated in FIG. 9 the mechanism for the flap 163 to engage a strap inserted into the buckle is formed when the buckle is closed by inserting the hook 164 on the upper plate 160 into the slot 212 in latch 210, illustrated in FIG. 13. The buckle illustrated in FIG. 14, depicts this embodiment with the buckle closed wherein with the hook 164 on buckle side A 182 is inserted into the slot 212 in latch 210.

The embodiment illustrated in FIG. 9 provides a mechanism to disengage the flap 163 from a strap inserted into the buckle. The embodiment illustrated in FIG. 13 provides a latch 210 on the lower plate 200. As illustrated in FIG. 14, when appropriately manipulated, the latch 210 releases the hook 164 from the slot 212, thereby enabling the upper plate 160 and lower plate 200, permanently connected by the hinge joint 174 on the buckle's opposing side B 183, illustrated in FIG. 9, to swing apart and the flap 163 to move up and out of the path of the strap.

In an embodiment illustrated in FIG. 10 a buckle's side A 182 has an opening 216 aligned with a similar opening 216 on side B 183 to support a spring bar shoulder pin 71, illustrated in FIG. 7. In an embodiment of the buckle illustrated in FIG. 9 the spring bar shoulder pin 71, illustrated in FIG. 7, attaches the buckle's mounting end 172 to a strap.

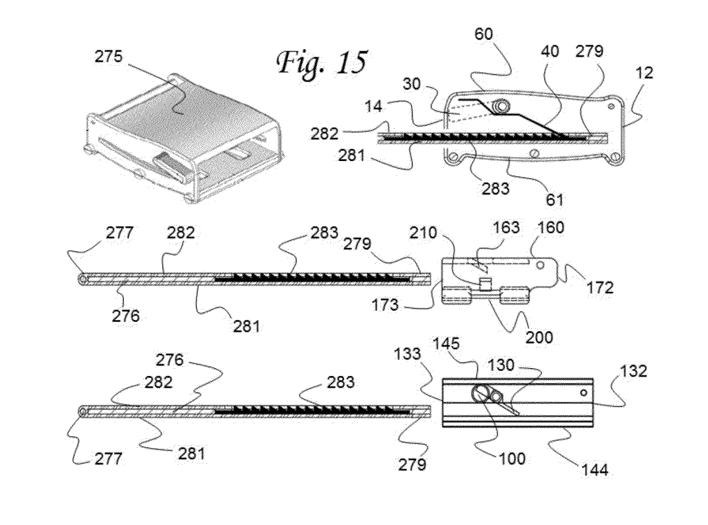

In some embodiments as illustrated in FIG. 15 the buckle upper plate 60, 160, 145, the buckle lower plate 61, 200, 144, the handle 30, the buttons 100, and the latch 210 have outward facing surfaces with a brushed steel finish 275.

In some embodiments illustrated in FIG. 15 the buckle is permanently connected to a first strap 276 of such a size for use to secure an object to a human wrist. In these embodiments the strap 276 provides a fixed end 277 adopted to permanently attach to the buckle's mounting end 12, 172, 132. In these embodiments the strap 276 further provides a free end 279 for insertion into the buckle's receiving end 14, 173, 133. The strap 276 further provides a finished side 281 adopted for viewing, and an opposed working side 282 whereon a slot is formed to provide for the permanent insertion of an engagement bar 283. The engagement bar 283 is further adopted with a aw toothed profile formed as such to engage the buckle's inward-directed flap 40, 163, 130. In these embodiments the engagement bar 283 is embedded far enough into the slot in the strap 276 that when worn on a human wrist the notches in the saw tooth profile do not significantly contact the human skin.

In the embodiment illustrated in FIG. 16 the buckle is permanently connected to a second strap 290 that, when added with a first strap 276, forms a combined strap that is of such a size for use to secure an object to a human wrist. In this embodiment the second strap 290 comprises a buckle end 291 adapted to permanently attach to the buckle, and a device end 292 adapted to permanently attach to a watch 293 or other devise. In some embodiments illustrated in FIG. 16 a spring bar shoulder pin 71 is provided to permanently attach the ends of the strap 276 and 290 to the watch 293 or other device, and the end of strap 290 to the mounting end 12 of the buckle. In this embodiment illustrated in FIG. 16 the second strap 290 further comprises a finished side 295 adopted for viewing, and an apposed working side 294 adopted for comfortable contact with a human wrist. This embodiment further comprises a watch 293 providing a strap-to-buckle side 297, adopted to permanently attach the watch 293 to the fixed end 292 of the second strap 290 with the buckle, and the strap-to-engagement-bar side 296 side adopted to permanently attach the watch 293 to the fixed end 277 of the first strap 276 with the engagement bar 283.

In other embodiments illustrated in FIG. 16 the buckle is used to form a wrist watch. In this embodiment the wrist watch comprises of a watch 293, a buckle 298, a buckle strap 290, an engagement bar strap 276, and an engagement bar 283. In this embodiment the watch 293 is attached permanently to the buckle strap 290 and to the engagement bar strap 276 by spring bar shoulder pins 71. Further in this embodiment the mounting end 12 of the buckle 298 is permanently attached to the opposed end 291 of the buckle strap 290 by a spring bar shoulder pin 71. Further in this embodiment the buckle strap 290 has a finished side 295 for viewing and a working side 294 adopted for comfortable contact with the skin. Further the buckle 298 has a receiving end 14 adapted to receive the substantially U-shaped free end 279 of the engagement bar strap 276. Further the buckle 298 has an engagement mechanism which includes an inward directed flap 40 adopted to engage the engagement bar strap 276 and operably prevent withdraw of the strap 276 from the buckle 298 without the use of holes that penetrate through the strap 276, thereby preventing wear and tear on the strap 276 and prolonging its useful life. Further the engagement bar strap 276 has a finished side 282 adapted for viewing and a working side 281 adapted with a slot formed in a shape to receive a permanently attached engagement bar 283. Further the engagement bar 283 illustrated in FIG. 18 has a smooth side 90 adapted for adhesive to secure the bar 283 inside the slot, and a notched side 91 provided with a plurality of saw tooth shaped notches to engage the flap 40 in the buckle 298 engagement mechanism illustrated in FIG. 16. In some embodiments illustrated in FIG. 15 the buckle has a disengagement mechanism adopted with at least a button 100, a handle 30, or a latch 210 to move the flap 130, 40, 163 from of the path of the saw tooth notched engagement bar 283 releasing the strap 276 from the buckle.

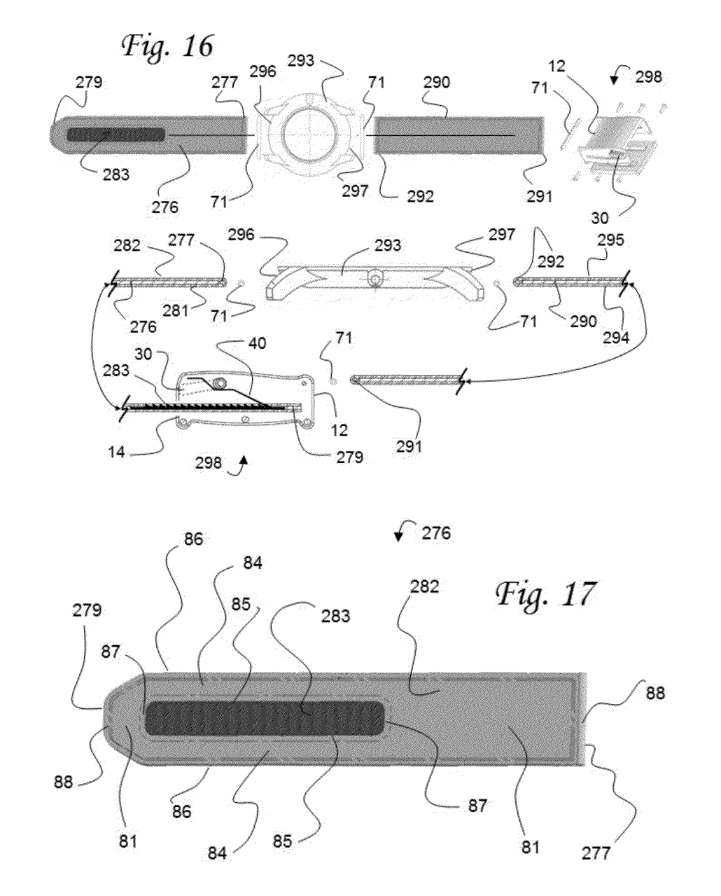

In other embodiments as illustrated in FIGS. 17 and 18, a strap 276 comprising a fixed end 277 and opposed free end 279 is provided. The fixed end 277 of the strap 276 is adapted to attach permanently to a buckle or another device, and the free end 279 is adapted for insertion into a buckle. In these embodiments, the free end 279 is constructed without engaging holes that pass through the strap 276. The free end can have any shape. In some embodiments, the free end is substantially U shaped, as illustrated in FIG. 17.

In some embodiments as illustrated in FIGS. 17 and 18 the strap 276 comprises a finished side 281 providing a smooth surface suitable for viewing, and opposed working side 282 providing a slot formed to house an engagement bar 283. In some embodiments an engagement bar 283 is further provided comprising a smooth side 90 and an opposing notched side 91, wherein the notched side 91 is comprises a saw tooth profile adopted to engage a buckle comprising an inward-directed flap 40, 130, 163, illustrated in FIG. 15, preventing the strap 276 from withdrawal from the buckle.

In other embodiments as illustrated in FIGS. 17 and 18 the strap's working side 282 comprises a slot formed in a shape that is narrower than the strap 276 wherein first portions 84 between the strap edges 86 and the slot edges 85 are sufficiently wide to cover recessed edges of the engagement bar 283. Further in other embodiments the first portions 84 are sufficiently wide for a bead of adhesive to be placed and properly set, and for a stitch to be made, to secure the engagement bar 283 inside the slot edges 85. Further in other embodiments the strap 276 comprises a slot formed in a shape that is shorter than the strap 276 wherein second portions 81 between the strap ends 88 and the slot ends 87 are sufficiently wide to cover recessed ends 92 of the engagement bar 283. Further in other embodiments the second portions 81 are sufficiently wide for a bead of adhesive to be placed and properly set, and for a stitch to be made, to secure the engagement bar 283 inside the slot ends 88.

In other embodiments illustrated in FIGS. 17 and 18 the engagement bar 283 comprises two opposing lengthwise oriented edges with recesses formed sufficiently wide to be covered by the first portions 84 of the strap 276. Further the engagement bar 283 comprises two opposing width wise oriented ends with recesses 92 formed sufficiently wide to be covered by the second portions 81. Further the engagement bar 283 comprises a smooth side 90 constructed with a textured surface adapted for receiving an adhesive which is applied before the engagement bar 283 is inserted into the strap slot. Further the engagement bar 283 comprises a notched side 91 formed with a plurality of notches constructing a saw tooth profile, oriented to the strap 276 such that the slanted sides 95 of the saw tooth notches are directed toward the substantially U shaped free end 279 of the strap 276, and the vertical sides 94 of the saw tooth notches are directed toward the fixed end 277 of the trap 276. Further the engagement bar 283 is sized to fit snuggly inside the strap slot.

Additionally provided is a watch face illustrated in FIG. 19, comprising a substantially planar surface suitable for application of a woven material 250. Further the watch face comprises a woven material 250 applied to the planer surface such that the material forms the surface the watch face. Further the watch face comprises time keeping dial pieces such as arms 252, numerals 253 and/or increments 254, as is customary or desired in the art, applied on top of the woven material 250. Further the watch face 251 provides a woven material 250 constructed of cloth fabric applied to the planer surface. Further the watch face 251 provides a woven material 250 that has a substantially stripped pattern. Further the watch face 251 provides a woven material 250 of substantially stripped pattern whose stripes are oriented in a direction starting from a top portion 258 of the watch face 251 and ending at a bottom portion 259 of the watch face 251.

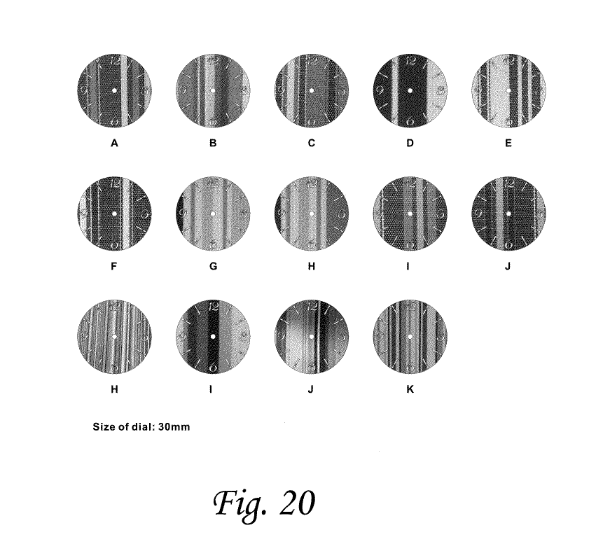

FIG. 20 shows 14 different design variations that illustrate various embodiments of the watch face. While these particular embodiments are 30 mm, they can be any size.

In view of the above, it will be seen that several objectives of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

What is claimed is:

1. A buckle having a mounting end and an opposed receiving end, wherein the mounting end is adapted to attach to a strap or another device and the receiving end is adapted to receive a strap, wherein
the buckle further comprises an upper plate and opposed lower plate;
the upper plate and lower plate combine to form an interior space that can receive a strap inserted into the receiving end of the buckle;
the upper plate and lower plate further combine to form a mechanism in the interior space that, when the mechanism is engaged, prevents the strap from being removed from the interior space when inserted into the receiving end and, when the mechanism is disengaged, allows the strap to be removed; and
the buckle can engage a strap without engaging holes that pass through the strap.

2. The buckle of claim 1, further comprising side A and side B, wherein
side A opposes side B on the buckle, and both side A and side B join the buckle upper plate with the lower plate;
side A comprises a substantially planer plate, whereon openings are formed therethrough adapted to support parts of the buckle that protrude inward through the interior to side B of the buckle, and aligned with areas on the buckle lower plate adopted for joining side A to the buckle lower plate, and
side B comprises a substantially planer plate, whereon openings are formed therethrough adapted to support parts of the buckle that protrude inward through the interior from side A of the buckle, and aligned with areas on the buckle lower plate adopted for joining side B to the buckle lower plate.

3. The buckle of claim 1, wherein the mechanism comprises
a pin adapted for an inward-directed flap,
a handle or button adapted to disengage the flap from the strap, and
a spring bar shoulder pin adapted for attaching the mounting end of the buckle to the strap.

4. The buckle of claim 3, further comprising
an inward-directed flap that engages the strap to prevent withdrawal of the strap, wherein the flap can disengage the strap to allow withdrawal of the strap.

5. The buckle of claim 4, wherein the inward-directed flap is attached to a handle and the pin is oriented perpendicular to the strap path and connects the handle to the inward-directed flap.

6. (canceled)

7. The buckle of claim 5, wherein the inward-directed flap is biased toward the buckle bottom plate thereon by a spring connected at the opposed end of the flap to the buckle upper late.

8. The buckle of claim 4, further comprising a disengagement mechanism comprising a handle, wherein engaging the handle rotates the flap up and out of the path of the strap.

9. The buckle of claim 4, wherein the inward-directed flap is operably connected to at least a first button, on side A or side B, wherein pressing the first button disengages the flap.

10. The buckle of claim 9, further comprising a second button on the opposing side of the buckle from the first button, wherein pressing the first button and the second button simultaneously disengages the flap.

11. The buckle of claim 9, further comprises a pin oriented perpendicular to the strap path, adapted therein as a fulcrum supporting the leveling motion on the inward-directed flap that operably connects the first button with the flap.

12. The buckle of claim 2, the mechanism further comprising
a latch therein formed as a fixed protrusion from one edge of the buckle lower plate, and
an inward-directed flap therein formed as a fixed protrusion from the buckle upper plate, wherein the flap can engage the strap to prevent withdrawal of the strap.

13. The buckle of claim 12, wherein the latch is adapted to engage and disengage the flap from the strap, and the mechanism further comprises
a pin adapted for the inward-directed flap,
an outward-directed hook therein formed as a fixed protrusion from one side of the buckle upper plate, and
a spring bar shoulder pin adapted for attaching the mounting end of the buckle to the strap.

14. (canceled)

15. The buckle of claim 14, the mechanism further comprising a latch wherein a slot is formed therethough for receiving the hook, wherein engaging the hook to align with the slot pivots the flap down and into the path of the strap.

16. The buckle of claim 15, further comprising a disengagement mechanism comprising a latch wherein engaging the hook to release from the slot pivots the flap up and out of the path of the strap.

17. (canceled)

18. The buckle of claim 1, further comprising a first strap of such a size for use to secure an object to a human wrist, the strap comprising
a fixed end adapted to permanently attach to the buckle,
a free end adapted for insertion into the buckle,
a finished side adopted for viewing,
a working side wherein a slot is formed thereon to receive an engagement bar, and
an engagement bar whereon one side a saw tooth profile is formed adopted to engage the inward-directed flap.

19. The buckle of claim 18, further comprising a second strap that, when joined with the first strap is of such a size for use to secure an object to a human wrist, wherein the second strap comprises
a buckle end adapted to permanently attach to the buckle,
a device end adapted to permanently attach to a watch or other devise,
a finished side adopted for viewing, and
a working side adopted for comfortable contact with a human wrist.

20. The buckle of claim 18, further comprising a watch having opposed strap-to-buckle and strap-to-engagement-bar sides, the strap-to-buckle side adopted to permanently attach the watch to the fixed end of the strap with the buckle, and the strap-to-engagement-bar side adopted to permanently attach the watch to the fixed end of the strap with the engagement bar.

21. The buckle of claim 1, having a wrist watch wherein the wrist watch comprises of a watch, a buckle, a buckle strap, an engagement bar strap, and an engagement bar, wherein
the watch is attached permanently to the buckle strap and to the engagement bar strap by spring bar shoulder pins;
the mounting end of the buckle is permanently attached to the opposed end of the buckle strap by a spring bar shoulder pin;
the buckle strap has a finished side for viewing and a working side adopted for comfortable contact with the skin;
the buckle has a receiving end adapted to receive the substantially U-shaped free end of the engagement bar strap;
the buckle has an engagement mechanism which includes an inward directed flap adopted to engage the engagement bar strap and operably prevent withdraw of the strap from the buckle without the use of holes that penetrate through the engagement bar strap;
the engagement bar strap has a finished side for viewing and a working side adopted with a slot formed thereon in the shape to receive an engagement bar;
the engagement bar has a smooth side and a working side, the smooth side adopted for adhesive to secure the bar inside the slot, the working side adopted with saw tooth shaped notches to engage the flap in the buckle engagement mechanism; and
the buckle has a disengagement mechanism adopted with at least a button, a handle, or a latch to move the flap from of the path of the saw tooth notched engagement bar releasing the strap from the buckle.

22. A strap comprising a fixed end and opposed free end,
the fixed end adapted to attach permanently to a buckle or another device, and
the free end adapted therein for insertion into a buckle,
wherein the free end is constructed without engaging holes that pass through the strap.

23-35. (canceled)

36. A watch face comprising:
a substantially planar surface, thereon suitable for application of a woven material, and further comprising of a woven material applied to the planer surface thereon such that the material forms the surface of said watch face, and upon which the time keeping dial pieces may be applied, substantially comprised of the arms and numerals or increments, as is customary or desired in the art.

37-39. (canceled)
